(19) United States
(12) Patent Application Publication
(10) Pub. No.: US 2007/0287631 A1
(43) Pub. Date: Dec. 13, 2007

(54) Agricultural or Horticultural Additive

(76) Inventor: Amaranathan Balasingham, Pukekohe (NZ)

Correspondence Address: YOUNG & THOMPSON, 745 SOUTH 23RD STREET, 2ND FLOOR, ARLINGTON, VA, 22202, US

(21) Appl. No.: 11/667,463

(22) PCT Filed: Nov. 15, 2005
(86) PCT No.: PCT/NZ05/00303

§ 371 Date: May 10, 2007

(30) Foreign Application Priority Data
Nov. 16, 2004 (NZ) 536594

(51) Int. Cl. A01N 25/00; A01N 25/30; A01N 65/00; A01P 21/00; C05F 11/00; C05F 7/00

(52) U.S. Cl. 504/118; 424/195.17; 424/727; 424/757

(57) ABSTRACT

The composition includes extracts from fast-growing plants (including seaweeds) mixed with phospholipids and a surfactant, presented at an acidic pH. It is sprayed on crop plants as a weak watery suspension to benefit plant growth and plant immunity/defense mechanisms indirectly. The level of natural defenses against pests and disease organisms is raised by included plant elicitors, effectors and stimulants. The ecological balance of soil bacteria is affected beneficially, contributing to the holistic effect. An arthropod knock-down effect is believed to be mediated through stimulation of commensal bacteria found on the epidermis of plants and of animals.

### FIELD

This invention relates to agricultural and/or horticultural additives of natural and sustainable origin, having an intended effect of promoting plant growth and of reducing the extent of parasitism such as by insects.

### BACKGROUND

In many agricultural sites, such as where intensive or relatively monocultural crops or livestock, or a combination, are raised, the farmer has a constant battle to suppress parasites such as insects, mites, fungi and microbes which attempt to consume his production before it can be marketed. Often, the preferred response to a particular problem has been a relatively specific “knockout” treatment such as use of an insecticide, vermicide, fungicide or similar; in accordance with the “magic bullet” since the time of Ehrlich with pharmacological therapeutics of synthetic or natural origins, and as exemplified with penicillin or a vaccine. Some of these have side effects of varying degrees of significance as well. Many agricultural problems arise from a desire to farm a single species all at the same phase of the life cycle, so that any pests that arrive can multiply rapidly if unchecked. Another problem is the desire of the market for totally unblemished products.

There is growing interest in alternative strategies for pest control, particularly in plants; strategies that have a primary effect on the plant tissues rather than on the infectious agents. They might have a primary effect on soil micro-organism balances. This is often a less target-specific form of pest control. Holistic approaches have not enjoyed the same acceptance as “magic bullet” type products of directed research for various reasons. The holistic theme of the present invention is supported by current horticulture-related research, for example: a Department of Multitrophic Interactions has been started in the Netherlands Institute of Ecology (KNAW) at Maarssen. Their interests include interactions between plants, above-ground and below-ground herbivores, pathogens and their natural enemies. The British Society for Plant Pathology presidential address for 2003 was on “Survival, surfaces and susceptibility—the sensory biology of pathogens” (J A Lucas) which begins by stating that the study of plant disease caused by pathogenic micro-organisms is a science of interactions: pathogen vs host, and the influence of the environment on both partners as well as on the interaction itself.

Example interaction means that are activated or increased when the host plant is under attack and experiencing stress and is activating cell repair include:
a) secretion of volatile substances* some having antimicrobial and anti-herbivore activity; also items selected from the range of: elicitors, receptors, effector molecules, activators, gene silencers and other activity modifiers, cofactors and substrates, one action of which is to activate defense mechanisms in neighbouring host plants,
   *Knudsen J T et al (1993) Phytochemistry 33253-280 “Floral scents—a checklist of volatile compounds isolated by head-space techniques” and others report over 1000 low molecular weight volatile substances reported to be emitted from plants. extra-floral nectaries (such as on cotton) to attract parasitoids with specifically utilizable sugars.

Some of these interaction means are relevant to ecologies below ground level.

Depending on the characteristics and nature of the elicitor of the defense (immune) system), the primary response mechanism induces one of three immune systems:
a) Systemic acquired resistance (SAR) which is induced by limited infection with a pathogen. Salicylic acid is the main signalling hormone and it is associated with expression of genes and release of disease preventing proteins.
b) Induced systemic resistance (ISR) is activated by non-disease causing micro-organisms. Jasmonic acid and ethylene are examples of signalling hormones involved. This system does not involve disease-preventing proteins. Environmental factors also induce this system.
c) Induced systemic resistance against chewing and biting insects is also dependent on jasmonic acid and ethylene, but requires increased levels of these regulators rather than an initial sensitivity to them as in (b). Induction of the synthesis of the insect attractants is a multistep biochemical chain involving jasmonic acid.

Plant extract treatments based partially or totally on seaweed extracts are well-known but appear to work after the added matter has been reduced to more or less elemental components, and these appear to work as fertilisers in the usual sense of upgrading an inorganic elemental limit to growth.

Other known plant or crop treatments used as preventatives rather than as “magic bullet” cures include growth promotants such as auxins (particularly cytokinins to promote root growth). Some bioremediation treatments include a cocktail of useful micro-organisms such as nitrogen-fixing bacteria. This would also have considerable advantages for those who wish to avoid close contact with the agrichemical industry. At this time, the over-use of agrichemicals (along with other environmental pollutants) is suspected of contributing to statistically raised morbidity and mortality in the human population—such as in relation to depressed sperm counts and raised incidences of various types of cancer.

### PRIOR ART

Acadian Agritech of Nova Scotia, Canada in a document entitled “Application Benefits” as downloaded on 1 Sep. 2005 from http//www.acadianagritech.com/plant/n_mode.html, describe attributes of a biodegradable liquid that is understood to be an extract of seaweed origin (as is the present application) having a generally beneficial and preventative effect on plants by inducing a mild localized and systemic acquired resistance response in foliage and a change in the micro-organisms in the rhizosphere, of benefit to the plant directly (such as through the change in ecology) and indirectly (through release of digestive breakdown products from pathogenic fungi, that induces a systemic acquired resistance). The presence or function of further active ingredients of the types named in the present invention is not stated. The present invention includes a capacity to “knock down” existing insects at the time of application, so having some curative properties as well as a generally beneficial and preventative effect on plants.

Kulenkampff, in U.S. Pat. No. 5,093,124 describes a biodegradable pesticidal composition for curing damage from arthropod or fungal pests. The composition includes predominantly an alkali metal soap and a second component for amelioration of the inherent phytotoxicity of the soap, namely either lecithin (phosphatidyl choline), a seaweed extract, or a mixture of both. The mixture is applied at about preferably 0.25% by weight of active ingredients in water. Concentrations (as sprayed) are surfactant X 10, seaweed X 1.6, lecithin X 45 The application rate is given only as “to runoff”. At col 3, line 61, it is said that the fungicidal properties of the soap of the composition will deteriorate at lower concentrations. Although this composition appears at first sight similar to that of the present invention, the present invention is not an alkali metal-soap (it is acidified to about pH 3.8 with citric acid), is used at one tenth the minimum concentration of Kulenkampff, and is used mainly as a preventative for stimulating the plant's own defenses, while Kulankampff's invention is used as a treatment.

### OBJECT

It is an object of this invention to provide a plant treatment; an holistic, preventative, bioremediation product, or at least to provide the public with a useful choice.

### STATEMENT OF INVENTION

In a first broad aspect the invention provides a composition of the organic, bionutrient type for the holistic prevention of plant diseases and parasitism and general improvement of plant structures, wherein the composition includes four major components:

an extract made from a selected quickly growing plant or seaweed,

a phospholipid (as an extract of plant origin),

an organic amine surfactant, and

an organic acid of a type found in plants,

the composition being applied to plants by spraying at a low concentration in an aqueous suspension, and the composition being capable when in use of improving at least one of: resistance of the sprayed plants to pathogens and parasites, the number of arthropods present on the plants, the growth rate of the plants, and the balance of soil micro-organisms so that it is more favourable to plant growth.

Preferably the relative proportions (as dry weight) of the ingredients are in the range of—extract: about 65%, phospholipid: about 1-5%, surfactant: about 15-30%, and organic acid: in an amount capable of rendering the pH of the composition to be applied in a range from pH=about 3.0 to pH=about 4.5.

In one option the composition is supplied in a dry form: convenient for storage or transport.

Alternatively the composition is supplied in a relatively concentrated aqueous suspension.

In a first related aspect the extract included in the composition provides at least one functional material selected from the range of [growth stimulants, organic elicitors and effectors, and functional nutrients] so that in combination with the remaining components of the composition the extract is capable of stimulating growth, of stimulating systemic acquired resistance, of stimulating induced systemic resistance, of stimulating commensal micro-organisms, and of stimulating soil micro-organisms.

Preferably the extract is obtained from a fast-growing seaweed, and more preferably the seaweed is of the species Ascophyllum nodosum, or optionally, kelps.

In a second related aspect the phospholipid is a lecithin of soy bean origin although mixtures, such as phospholipid mixtures including linoleic acid, are acceptable: the phospholipid serving to enhance cell membrane restoration, so that in combination with the remaining components of the composition the composition enhances resistance to pathogenic fungi.

In a third related aspect the surfactant is a coconut oil diethanolamine condensate and the surfactant assists in absorbtion of the composition over sprayed plant leaf surfaces.

Preferably the pH of the mixture (as found in a dilute solution) is lowered to from typically about over 8 down to about 3.8 by the addition of a sufficient amount of citric acid or an equivalent plant-compatible organic acid.

In a second broad aspect, the composition provides means for reducing an arthropod parasite burden on farmed organisms (including plants and animals), the composition having an effect of encouraging the production of arthropod-adverse or arthrocidal compounds (including without limitation the type known as phytoalexins or other anti-biosis type compounds) by micro-organisms present on or near the farmed organisms, so that the farmed organisms exhibit additional growth at least some of which is a response to the reduced parasite burden.

In a third broad aspect, the invention provides a method for applying a composition as previously described in this section for control of insect damage in plants of the cabbage family, wherein the method includes the steps of preparing an about 0.1% suspension (or more) of active ingredients in water and applying the suspension to the plants by spraying at a rate of about 0.5 litre to 1 litre per hectare at weekly intervals while the plants are small, and then at fortnightly intervals.

In a fourth broad aspect a reduction of molluscs adverse to plants (slugs and snails) has been noted but this may be a consequence of reduced algal growth, itself known to result from application of the composition.

### PREFERRED EMBODIMENT

The description of the invention to be provided herein is given purely by way of example and is not to be taken in any way as limiting the scope or extent of the invention.

Throughout this specification, unless the text requires otherwise, the word “comprise” and variations such as “comprising” or “comprises” will be understood to imply the inclusion of a stated integer or step or group of integers or steps but not the exclusion of any other integer or step or group of integers or steps.

The inventor has largely based his invention on providing one or more exogenous substances that mimic the inducers (elicitors) of the defense (immune) systems of plants and thereby anticipate or amplify the natural response of the farmed crop.

It appears to the inventor that there are benefits from applying treatments that “help the plants to help themselves” such as by promoting the plant's own biosynthesis and distribution of phytoalexins.

It should be noted that total eradication of a particular pathogen is not a goal although that may be possible using the right agrochemical cures. Reduction of the pathogen burden to a low level is a goal.

### EXAMPLE 1

This invention relates to an ecosystem in which farmed organisms (plants) are farmed. A composition for bioremediation is provided, causing the promotion of plant growth and a reduction of insect burden. A preferred composition in overview includes:

an extract from tissues of a fast-growing plant or seaweed (or as detailed below)

a phospholipid, preferably lecithin,

and a surfactant. Preferably the surfactant is a coconut palm-derived amine.

Water is added to bring the composition as sold to be a dilute or a strong solution; otherwise the composition may be made on a dry basis for later mixing with water.

A preferred rate of application is usually a 0.1% solution of dry active matter in water.

The currently preferred seaweed extract (sold as “Acadian Seaplants Seaweed Extract”, Acadian Seaplants Limited, Nova Scotia, Canada) is already sold by that company for use as a plant fertiliser, and the company summarises a number of field trials showing a positive effect of application onto a variety of commercial crops. The field trial summaries do not point out what component is/are supplemented if if there is another mechanism involved, but the company's web site suggests that short-chain carbohydrates, unusual amino acids (betaines), over 60 chelated micro- and macro-nutrients, and other compounds, have some plant biostimulant effect and discourage sap-suckling insect attack. (http://www.acadianseaplants.com/technicalproducts.html, available on Nov. 12, 2004). The preferred raw material is the seaweed Ascophyllum nodosum. The additives described in this invention are novel and in combination the mixture provides effects including at least some synergistic effect beyond their known effects if used separately. To the inventor's knowledge this company is the only one producing a soluble powder of good quality (as specified herein); other seaweed companies produce pulp or liquid. Other sources of seaweed extract may be suitable.

Manufacturing Method, with Details of Our Understanding of the Purpose(S) of Various Components.

(Please note: Any attempts provided herein as “theory” by way of explanation of the observed results have been provided in good faith. Should it later be realised that a different explanation is more appropriate than the one offered, such a change must not be taken as invalidating the patent).

1. The base material is a water soluble extract powder of any plants that grow fast (>0.5 m/day) in length e.g. seaplants (seaweed) such as Ascophyllum nodosum. Desert or arid plants that have potential to survive harsh conditions and grow fast when conditions allow, such as Yucca spp are an alternative. A desired amount of this material is placed in a mixing vessel capable of holding a further 35% (approximately) of dry or relatively dry material. All measures are given herein as weights.

Alternatively, the invention may use liquid concentrated extracts obtained from similar type fast-growing plants including those plants that grow quickly in a desert after sporadic rain, or a mixture of land and sea origin plants.

Theory:

This composition is made using plant extracts that are intended to correct areas of imbalance in any overtaxed eco-system. Benefits derived from this component appear at least in part to be that commensal micro-organisms existing in contact with the farmed organisms (animals or plants) are capable of being provoked or stimulated or otherwise caused to produce insecticidal compounds by the application of a composition according to the invention. Although the family of toxins produced by Bacillus thuringiensis (Bt) organisms may not one be of those involved they comprise an illustrative microbially and field-produced group of insecticides. Other benefits of the composition are that it is a crop-supporting plant extract, added as a cofactor and nutrient (and perhaps with further functions) to sustain the increased activities of the eco-system. Other plant extracts may be included to counter any possible side effects from the actions of the two main extracts.

Bio-availability enhancers are also added to expedite the transfer of the benefits of the formulation to the cellular components of the live ecosystem including the soil ecosystem. For example, these extracts may contain high level of enzymes or analogous substances and/or release substances which we call “the elicitors” from the fungal and bacterial cell walls. The elicitors diffuse through the animal and plant cells and may be or act like hormones (with the help of the coconut or other palm-derived amines, and the phospholipids). Elicitors then bind to specific receptors on the plant cell membranes and induce metabolism (phospholipids from lecithin, and nutrients from seaweed such as kelp may provide substrates) of (for example) phytoalexins On the other hand the extracts may act on the mechanisms involved in expression of genes. The composition also works by inducing microbial systems to release compounds that may have antibiosis-type effects.

2. Add about 1%-5% of plant extract with a high phospholipids content to the contents of the mixing vessel. Lecithin (phosphatidyl choline) is a good source of phospholipids and one preferred commercial source of lecithin is soybean.

Theory: Benefits Derived from this Component—

The phospholipids appear to enhance cell repair and increase the fungicidal effect of the mixture. Many forms of this material also contain an antioxidant—omega 3 linolenic acid. The material acts as an emulsifier of the plant oils in the mixture. Free linolenic acid may act to increase suppleness of the cell wall.

Choline, a closely related phospholipid, may help transport elicitors, nutrients and phytoalexins in and out of cells and may also be used.

The materials may serve as natural preservatives and be substrates for production by the treated plants of phytoalexins.

3. Add about 15% to 30% palm derived surfactants to the contents of the mixing vessel.

Coconut or palm-based, amine-rich products are preferred, such as coconut oil diethanolamine condensate or particularly the compound cocamide diethanolamine (CAS 68603-42-9), supplied as a viscous yellow liquid that is a non-ionic surfactant for use in part as a wetting agent. (Note: this is not a soap (an alkali metal salt with high pH).

Theory: Benefits Derived from this Component—

The component aids cells of the treated plants to absorb nutrients and other beneficial compounds. The amine in the palm-derived extract appears to act like other amine hormones that bind to receptors at the cell surface (largely cells within the microbial flora of the soil) and act through second messengers. Synthesis of the second messengers inside the cell is stimulated by binding of the hormone at the cell periphery. Accumulation of the second messenger evokes metabolic changes inside the cell. (See “BIOCHEMISTRY” Christopher K Mathews, K. E. Van Holde, et al. Benjamin Cummings Publishing Company 1999). One might question this theory by asking whether the same effects are seen in a sterile environment, where the composition could supply micro-nutrients and trace elements (at the usual rate of application) to the plants under treatment. The resulting composition has been found to be not significantly effective in a sterile environment. Its actions and benefits are derived from its stimulating action on microbial and other living components (such as higher plants) of the ecosystem. The product may influence production of phytoalexins. The product may influence production of lignin for healing of damaged plant tissues.

4. Add a compatible acid, such as citric acid or an equivalent, in order to stabilise the mixture by acidification. The preferred original seaweed extract typically has a pH of about 8-10. The final pH is preferably about 3.8. If water is not to be added to the mixture at this time the correct amount of citric acid to add in dry form—crystals or powder—is preferably determined by extrapolation from a trial on a small quantity.

5. Water may or may not be added to the mixed materials,—depending on the concentration of raw material required: shipping, storage or packing factors, and the form in which the mixture is to be used.

Results

Various trials shall be described.
1. Marigolds. This experiment was not a commercially useful trial. Instead, it showed some mechanisms by which the invention (called “Agrizest”) operates. Observation, after treatment: slow yellowing of the lower leaves and subsequent fall of the mature leaves. Explanation: The plant's innate hormones, including jasmonic acid, abscisic acid and ethylene have been produced in excess, accelerating the plant's senescence, through the Induced Systemic Response. Observation: at the apex of the plant the “witch's broom” syndrome, also seen when high doses of growth hormone are applied, indicates that the innate growth system of the plant has been over-stimulated.
2. Cabbages A trial in Australia of the “Italy” variety gave the following results: Control (no treatment) cabbage leaves at the time of harvesting were eaten back to skeletal components by insects—and hearts were infrequently harvestable. With two sprays in the first week and one spray 2 weeks later, the amount of damage was less: hearts were infrequent, most outer leaves had been eaten, and a third group, sprayed twice in the first week and every 2 weeks thereafter until harvest very little damage to the outer leaves and consistently good hearts. Photographs are striking but incompatible with reproduction in patent specifications. (Similar results observed on cauliflowers).
3. Fennel. Stimulation of growth and greater consistency of plant size in fennel seedlings three days after one treatment with “Agrizest” is demonstrated, as compared to other organic nutrient mixtures.
4. Grapes. (a Viogier and Pinot Noir varieties vineyard)
   a) Vine infested with blister mite. Every second row was treated with “Agrizest” and every other row was treated with a control treatment of sulphur, fish nutrient and seaweed sprays. Total leaf spots due to blister mite damage (Viognier variety) control: total spots 79 on 21 damaged leaves out of 50 randomly sampled leaves (average 3.8 spots per damaged leaf, leaf size 274.5 “Agrizest” treated plants: total spots 44 on 15 damaged leaves out of 50 (average 2.9 spots per damaged leaf, leaf size 311.5—a 44% reduction in spots.
   b) Enhancement of growth. Treatment resulted in larger and greener leaves than for the control plants. Leaf width index: (Viognier variety) control: 7.0, “Agrizest” 7.6, an 8.6% increase. (Pinot Noir variety) control: 8.9, “Agrizest” 9.1, a 2.2% increase.
   c) Sugar content of crop. The Brix level of sugars in the grapes was control: 19.8, 20.0, “Agrizest” 21.2. 20.7, a 7.1% 3.5% increase.
5. Cycad plants having insects on young leaves.
   a) One day after spraying the plant was free of insects and appeared to be invigorated by a change in gene expression within the cycad as a result of treatment.
   b) An adult scale infestation was treated with “Agrizest” weekly. The treated leaves were relatively free of crawler and juvenile scale, but an untreated (shaded from spray) leaf had a high level of infestation.
6. Courgette and cucumber plants. Older leaves had been destroyed by powdery mildew infection. Younger leaves that had been treated weekly with “Agrizest” were able to resist infection. The plants continued to flower and healthy courgettes were harvested.
7. Geranium plants. Attacks by caterpillar, slugs and snails were halted after weekly spraying with “Agrizest”. The plants appeared to be invigorated and were greener. Reduced presence of slugs and snails has been noticed in gardens where “Agrizest” has been sprayed.

### EXAMPLE 2

Knock-down effects in general. When treating insects on “row crops” with the usual application rate of about 0.5 l/ha of a 0.1% solution of the composition, an initial “knock down” of insects within a few minutes is noted. Observations indicate that several different mechanisms are involved. For example in the cabbages trial referred to previously, it was noted that the white fly larvae on the cabbage leaves soon fell off and were moving about, the same at the end of the day, and in three days time they were gone. It appeared that the leaf had become unpalatable. Such observations could not easily be explained by a physical effect of the composition on the insects (such as by the soap of the prior-art Kulenkampff: U.S. Pat. No. 5,093,124). The early phase is presumed to be an early metabolic response (comprising production of toxins) by commensal micro-organisms on the epidermal surfaces of the plant leaves. Later, further micro-organisms in the soil may also contribute. In a second phase (covering the three-day period), the plant vigour changes and this phase appears to involve the production of effective amounts of phytotoxins. The second phase has an onset of 1-2 days for seedlings and about 2-3 weeks for mature plants (such as grapes or tree crops). Users are advised to re-spray the composition at intervals of about 7-14 days for seedlings, and 14-21 days for mature plants.

Livestock. At this time use of the knock-down aspect of the invention is less well developed and tested. The composition may be sprayed onto farmed animals (including birds) whereupon the effects that soon follow suggest that again commensal bacteria or other micro-organisms present on the epidermis and in the hair, far, scales or feathers are stimulated to produce some insecticidal substances that adversely affect parasitic arthropods present upon or about the farmed animals. These parasites include (without limitation) fleas, mites, ticks, keds, lice, and flies, and their larvae. Although the invention may not provide the dramatic results usually expected of a synthetic insecticide applied in an adequate concentration (or one including natural components such as pyrethroids) it does tilt the balance of the ecology of the animal's insect burden and has met the requirements for materials for use in organic fanning. Interestingly this example includes no plant or soil life forms and the nature of the composition may be altered from that given in relation to example 1.

Variations

The invention may be extended to the provision of specific micro-organisms found to be compatible with applications of mixtures according to the invention, mixed with the invention or supplied separately for co-application. The mixture may be presented in a less acidic form if living material is included.

The invention can be used on the surroundings of animals such as barns (holding straw and fertiliser) and in parts of fields such as around drinking troughs or sleeping areas.

Fertilisers, micronutrients and trace elements may be added to the mixture as indicated, as long as they are compatible.

### INDUSTRIAL APPLICABILITY AND ADVANTAGES

This includes notes relating to Industrial Applications.
1. Use 1:1000 dilution or, if required, a more concentrated form for crop and stock applications. (Most other nutrient and natural pesticide products are applied as a 1% solution). Rate: 0.5 litres per hectare for row crops, 1 litre per hectare for established plants (such as grapes, tree crops, etc).
2. Repeat every 7-21 days.
3. The diluted spray has a knock down effect on insect pests. (but not if used in vitro—in the absence of a living ecosystem)
4. Has fungicidal effect on plants and stock
5. Appears to build immunity to pests and disease.
6. Appears to reduce physical damage on crops and stock from insect, disease and environmental stresses.
7. Acts as a growth stimulant.
8. Reduced odour in the barns and other stock holding environments.
9. Speeds up healing of damaged plant tissue.
10. Has synergistic growth promoting effect when 1% fish nutrient is added to the diluted spray mix and applied to crops.
11. Toxicological tests show that the product when used as recommended has no adverse toxicological effect on marine life or animals and is benign in the environment.
12. The composition, being based on plants, minerals and extracts, all derived from sustainably harvested renewable resources, comprises a “Certified Organic Input” product to support intensive farming without voiding the organic status of the produce. The product has a broad seasonal relevant application time, and no “with-holding periods” are involved. It is a sustainably produced product.
13. The resulting composition comprises an organic nutrient that invigorates the ecosystem and enables production of clean and healthy crops and stock in intensive farming; also sustains intensive farm (including horticultural) production.
14. The resulting composition boosts the natural synergistic system that cleans, nourishes, protects and recycles materials to sustain an invigorated eco-system.
15. The resulting composition acts as a tonic that boosts immune, health, healing and digestive systems in crops and stock.
16. The resulting composition does not work like conventional pesticides or medicines which are usually single-purpose treatments although they may have deleterious side-effects.
17. Because the composition works through a system rather than on a single target it delivers a range of benefits in intensive farming. By working on the biological system as a whole rather than on “targets” the composition provides treatments that are environmentally benign, generally applicable (rather than specific to a particular disease) and non toxic.
18. The composition simulates the combined benefits of an insecticide, fungicide, growth regulator and fertiliser when applied within the ecosystem.
19. The composition is not effective in a sterile environment. Its actions and benefits are mainly derived from its stimulating action on microbial and other living components of the ecosystem.
20. The composition, when applied to plants or stock, also has an immediate reducing effect on the insect population (indirect knock down properties). Plants and animals appear to resist disease infection. They overcome environmental stress. The overall result is clean and healthy crops and stock.

Finally, it will be understood that the scope of this invention as described and/or illustrated herein is not limited to the specified embodiments. Those of skill will appreciate that various modifications, additions, known equivalents, and substitutions are possible without departing from the scope and spirit of the invention as set forth in the following claims.

I claim:

1. A composition of the organic, bionutrient type for the holistic prevention of plant diseases and parasitism and general improvement of plant structures, characterised in that the composition includes four major components:
a) an extract made from a selected quickly growing plant or seaweed
b) a phospholipid (as an extract of plant origin),
c) an organic amine surfactant, and
d) an organic acid of a type found in plants,
the composition being applied to plants by spraying at a low concentration in an aqueous suspension, and the composition being capable when in use of improving at least one of: resistance of the sprayed plants to pathogens and parasites, the number of arthropods present on the plants, the growth rate of the plants, and the balance of soil micro-organisms so that it is more favourable to plant growth.

2. A composition as claimed in claim 1, characterised in that the relative proportions (as dry weight) of the ingredients are in the range of—extract: about 65%, phospholipid: about 1-5%, surfactant: about 15-30%, and organic acid: in an amount capable of rendering the pH of the composition to be applied in a range from pH=about 3.0 to pH=about 4.5.

3. A composition as claimed in claim 2, characterised in that the composition exists in a dry form.

4. A composition as claimed in claim 2, characterised in that the composition exists in a concentrated aqueous suspension.

5. A composition as claimed in claim 1, characterised in that the extract provides at least one functional material selected from the range of [growth stimulants, organic elicitors and effectors, and functional nutrients] so that in combination with the remaining components of the composition the extract is capable of stimulating growth, of stimulating systemic acquired resistance, of stimulating induced systemic resistance, of stimulating commensal micro-organisms, and of stimulating soil micro-organisms.

6. A composition as claimed in claim 5, characterised in that the extract is obtained from a seaweed

7. A composition as claimed in claim 1, characterised in that the phospholipid is a lecithin of soy bean origin and the phospholipid enhances cell membrane restoration, so that in combination with the remaining components of the composition the composition enhances resistance to pathogenic fungi.

8. A composition as claimed in claim 1, characterised in that the surfactant is a coconut oil diethanolamine condensate and the surfactant assists in absorbtion of the composition over sprayed plant leaf surfaces.

9. A composition as claimed in claim 1, characterised in that the composition provides means for reducing an arthropod parasite burden on farmed organisms (including plants and animals), the composition having an effect of encouraging the production of arthropod-adverse or arthrocidal compounds (including without limitation the type known as phytoalexins) by micro-organisms present on or near the farmed organisms, so that the farmed organisms exhibit additional growth at least some of which is a response to the reduced parasite burden.

10. A composition as claimed in claim 9, characterised in that the composition provides further means for reducing an arthropod parasite burden on farmed plants, the composition having an effect of encouraging the production of arthropod-adverse or arthrocidal compounds (including without limitation the type known as phytoalexins) by the plant, so that the arthropod parasites appear unable to eat the plant for at least a few days, and disappear.

11. A composition as claimed in claim 10, characterised in that the composition has a longer-term effect of causing additional growth in treated plants, at least some of which growth is a response to the reduced parasite burden.
